(19) United States
(12) Patent Application Publication
(10) Pub. No.: US 2022/0340456 A1
(43) Pub. Date: Oct. 27, 2022

(54) ELECTROLYTIC CHLORINATOR WITH INDIVIDUALLY REPLACEABLE ELECTRODES AND METHODS AND SYSTEMS FOR USE THEREOF

(71) Applicant: Custom Molded Products, LLC, Newnan, GA (US)

(72) Inventor: Steven L. Andrews, Newnan, GA (US)

(21) Appl. No.: 17/725,972

(22) Filed: Apr. 21, 2022

Related U.S. Application Data
(60) Provisional application No. 63/177,458, filed on Apr. 21, 2021.

(51) Int. Cl. C02F 1/461; C02F 1/467

(52) U.S. Cl. CPC C02F 1/46109; C02F 1/4674; C02F 2001/46152; C02F 2201/004; C02F 2303/04; C02F 2103/42

(57) ABSTRACT

A chlorinating system includes an electrode assembly comprising a plurality electrode blades, a cap electrically and mechanically coupled to the electrode assembly, and a housing for enveloping the electrode assembly in an interior compartment of the housing. The housing exposes the electrode assembly to an inlet and outlet of the housing. The cap is removable from the housing and allows for the individual replacement of single electrode blades forming the electrode blade assembly.

### CROSS-REFERENCE TO RELATED APPLICATIONS

This application is a nonprovisional application that claims priority to, and the benefit of the filing date of, U.S. provisional application No. 63/177,458 filed on Apr. 21, 2021, entitled “ELECTROLYTIC CHLORINATOR WITH INDIVIDUALLY REPLACEABLE ELECTRODES AND METHODS AND SYSTEMS FOR USE THEREOF”, which is incorporated by reference herein in its entirety.

### BACKGROUND OF THE INVENTION

### Technical Field

The present invention generally is in the field of chlorinating devices and methods for chlorinating spas, swimming pools, hot tubs, garden baths, and the like. The present invention more particularly is in the field of electrolytic chlorinators with replaceable electrodes for spas, swimming pools, hot tubs, garden baths, and the like.

### Prior Art

Saltwater systems have become increasingly popular because they offer many benefits over a standard fresh water chlorine pool. Saltwater swimming pools and spas draw on dissolved salt in the water to generate chlorine. The salt cell, or chlorine generator, utilizes electrolysis to break down the salt in the water. The chemical reaction created by electrolysis produces chlorine in the form of sodium hypochlorite and hypochlorous acid. The sanitizing/disinfecting/oxidizing agents derived from the salt are the same as those present in the solid or powdered chlorine commonly used in swimming pools. This means a saltwater pool is not actually chlorine free. It simply utilizes a chlorine generator instead of being dependent on chlorine added in other forms.

An important advantage of a saltwater system is that saltwater pools have reduced amounts of chloramines. Chloramines are a by-product of oxidation, or the breakdown of matter, in the pool water, and are the primary cause of eye irritation and a pungent “chlorine” smell. The process of electrolysis oxidizes or eliminates chloramines.

A typical salt chlorine generator contains two parts: an electrolytic cell and a controller. The cell is the part that converts the salt into chlorine. Water passes through the cell and over electrically charged electrodes (cell blades or plates). The electrodes can be made from any electrically conductive material but are frequently constructed of titanium due to its high resistance to corrosion. Additionally, the electrodes are typically coated with metallic oxides such as, for example, ruthenium, iridium, platinum, rhodium, and palladium, that serve to reduce the oxidation of the titanium electrodes.

The electrodes are typically made as flat blades and the arrangement that presents the best use of surface area is a stack of parallel blades with alternating polarities (for example, cathode, anode, cathode). While other flat and non-flat blade geometries are possible, the flat parallel stack is practical and is widely used in the industry. The cell blades are charged by the controller, which provides the electricity.

The controller or control board typically allows for adjustment in the level of chlorine in the pool. The system may include various sensors to detect the presence of water or monitor flow, salinity, chemical concentrations, ORP, pH, etc. In certain systems it is possible to connect the salt chlorinator to a pool automation system to monitor and control it by a remote or mobile device.

An electrolytic cell is composed of at least two immersed electrodes to which a difference of potential is applied. As the electrolytic is a conductor (salt water in the case of a pool), the applied difference of potential generates an electrical current that circulates through the electrodes and power source creating a series of chemical reactions inside the cell. One of the results of these reactions is the liberation of chlorine.

The amount of chlorine produced is determined by the electrical current and the surface area of the electrodes. Most systems allow for the current to be adjusted within a certain range for variable chlorine output. However, for practical and technical reasons (electrode deterioration), the electrical current cannot be increased indefinitely. Therefore, chlorine output capacity is generally determined by the electrode surface area and can be increased by increasing the number of electrodes in the cell or increasing the size of the electrodes in the cell. The same cell may be capable of holding a varying quantity of electrodes or electrodes of varying size in order to treat pools or spas of varying size.

The cells can have a bi-polar or mono-polar electrical design. In a bi-polar cell, only the two outside blades are connected to power and the electrical current must jump from blade to blade to complete the circuit. This requires the spacing between the cell blades to be very narrow in a bi-polar arrangement, and as a result typically they can only be cleaned by soaking in a mild acid solution (for example, 1 part HCl to 15 parts water) for a period of time. However mono-polar cells, such as the PowercleanTM Salt brand sold by CMP (the assignee), power each electrode blade individually allowing for the blades to be spaced farther apart to facilitate easy cleaning without acid.

Typically, mono-polar cells can be cleaned by sliding a slim tool (plastic or wooden so as not to damage the coated electrodes) between the blades to clear away scaling. More details on bi-polar versus mono-polar design can be found at https://www.linkedin.com/pulse/electrochlorination-cells-configuration-design-enrico-volpi/.

Electrolysis naturally attracts calcium and other minerals to the cell blades. Thus, depending on water chemistry and magnitude of use, the cell will require periodic cleaning to remove the buildup of calcium compound crystals, such as calcium carbonate or calcium nitrate. Regular maintenance is important as excessive buildup can reduce the effectiveness of the cell and may cause damage to the cell. Running the chlorinator for long periods with insufficient salt in the pool can strip the coating off the cell blades, as can using too strong an acid wash.

In both bi-polar and mono-polar systems, the polarity of the cell blades can be reversed (anodes turn to cathodes and vice versa) which can help to dissolve some of the buildup on the cell blades. This is called a “Reversed Polarity” or “Self Cleaning” setting. However, manual cleaning is usually still necessary at times even with this feature.

Typically, even well-maintained electrodes of any salt cell will need to be replaced after about 3-7 years (depending on the model and other variables). This is why many salt cell systems allow for the electrode assembly to be replaced.

Prior Art pool salt systems offer various ways in which to replace a damaged or worn out cell assembly. Many offer a cartridge solution where all electrode blades are replaced together as a sub-assembly. Some of these include a cap or other means to sealingly engage the replacement cell cartridge with the cell housing. Another option is to offer a “disposable” cell design.

These disposable cells are often cheaper products only meant to last one or two pool seasons. They are typically sealed units without any replaceable internal components, and they often attach to the plumbing with threaded unions to allow for the entire unit to be removed when necessary. However, in both of these examples of disposable cells and cartridge-style cells, often not all of the components being replaced are damaged or worn out. It would be advantageous to be able to selectively replace only the components that are worn out and are in need of replacement.

One reason the prior art chooses to replace all the electrode blades at once is that the cell assembly must remain watertight. Typically, this is achieved by anchoring the blades in a mounting cap and sealing it with a non-conductive potting compound such as epoxy. The mounting cap then can be easily attached to the cell housing in a watertight fashion using threads, bayonet locks, nut/bolt/gasket, or any other means known in the art. Some examples of this can be found in US Patent Publication No. 2011048964A1, U.S. Pat. No. 10,155,679, and U.S. Pat. No. 10,156,081.

Another reason why the prior art usually requires replacement of all electrode blades is that many pool salt cell electrodes are welded or soldered to make the electrical connections. However, this can present a challenge with the coated electrode material. Any time an electrical connection is made internal to the cell housing, the joined metals must be the same material or galvanic corrosion will rapidly degrade the contacts.

Also, to achieve a robust electrical connection, any active coatings on the electrodes should be removed to get to un-oxidized base metals. For example, if an electrode is made from titanium with an iridium oxide coating, then the coating should be removed and a suitable titanium connector must be joined gas-tight to effect a solid connection. This is not only expensive in terms of material and parts but also in assembly labor.

There is, accordingly, a need for new and improved salt chlorine generator or electrolytic chlorinator which does not require the replacement of all electrode blades at once. There also is a need for improved electrolytic chlorinators for artificial bodies of water and the like which permits replacement of individual electrodes. It is to these needs and others that the present invention is directed.

### BRIEF SUMMARY OF THE INVENTION

A method and an electrolytic chlorinator system are disclosed that allow for the replacement or servicing of individual electrode blades (or an electrode assembly) where money can be saved by replacing only the components of the salt cell that need replacement.

The electrolytic chlorinator system comprising an electrode assembly comprising a plurality of electrode blades, a cap mechanically coupled to the electrode assembly, and a housing for enveloping the electrode assembly in an internal compartment of the housing and exposing the electrode assembly to an inlet and outlet of the housing. The cap is removable from the housing and allows for the individual replacement of the electrode blades forming the electrode assembly.

The method comprises:

removing the cap from the housing to thereby remove the electrode assembly from the internal compartment of the housing;

at least partially disassembling the electrode assembly;

replacing one or more of the electrode blades with one or more respective replacement electrode blades;

reassembling the at least partially disassembled electrode assembly such that the reassembled electrode assembly includes said one or more replacement electrode blades; and

coupling the cap to the housing such that the reassembled electrode assembly is enveloped in the internal compartment of the housing.

The method and system provide several benefits, such as, for example, a lower cost to ship individual electrode blades for repair/warranty type repairs. The individual electrode blades are typically more economical to carry in inventory than full/complete replacement salt cell assemblies. The method and system may provide the ability to completely disassemble the electrode blades from the salt cell, which in turn, makes thorough descaling/cleaning easier compared to prior art salt cells which do not allow for disassembly of the salt cell by service technicians or consumers.

The method and system may allow salt cells with two or more blades, or any multiple thereof (including odd multiples—i.e., three, five, etc.), where the number of blades needed for an artificial body of water may directly correspond to the amount of chlorination (and/or the size of the artificial body of water) that is desired for an artificial body of water. Lower electrode blade counts may provide for a lower cost to “upgrade” if more chlorine is later desired/needed for an artificial body of water. In other words, with this method and system, cells having a low electrode blade count (and lower chlorine output capacity) can provide users with an option to “upgrade” to a higher blade count (and higher chlorine output capacity) by adding individual electrode blades to their existing salt cell if more chlorine is later desired/needed for an artificial body of water. Similarly, a blade sub-assembly with a low blade count may be swapped out entirely for another blade sub-assembly (with a higher blade count, for example) without requiring the user to replace the cell cap or cord if those components are still in good working order.

The method and system, by allowing the replacement of individual electrode blades, substantially reduces waste compared to prior art cartridge systems and “disposable” prior art salt cells. The method and system provide an ability to sell reconditioned electrodes or electrode assemblies, reusing a higher percentage of the total components (in addition to repurposing cell blades, the potted electrode caps and cord assemblies may be reused).

With respect to shipping the replacement blades, packaging materials for individual replacement blades is substantially reduced compared to replacement cell assemblies which occupy a significantly larger packaging volume. The method and system may eliminate a skilled technician to weld or solder electrodes. The method and system may eliminate potential failure modes due to inconsistent welding (less scrap and lower environmental impact) compared to prior art salt cells which require precision welding form a skilled technician.

The mechanical fasteners along with the conductive and non-conductive spacers may ensure uniform alignment of electrode blades (which may increase cell life and may improve performance of the salt cell overall). The fasteners and spacers may improve structural integrity of the salt cell assembly and they may make it easier to inspect a salt cell for quality control relative to prior art systems which use welding/soldering connections within their salt cells.

A complete understanding of the present invention may be obtained by reference to the accompanying drawings, when considered in conjunction with the detailed description of preferred embodiments, in which like elements and components bear the same designations and numbering throughout the figures.

### BRIEF DESCRIPTION OF THE DRAWINGS

In the drawings, like reference numerals refer to like parts throughout the various views unless otherwise indicated. For reference numerals with letter character designations such as “102A” or “102B”, the letter character designations may differentiate two like parts or elements present in the same figure. Letter character designations for reference numerals may be omitted when it is intended that a reference numeral to encompass all parts having the same reference numeral in all figures.

FIG. 1 is a diagram of a filtration and chlorinating system of an artificial body of water, like a pool or spa, that includes an electrolytic chlorinator and a control center.

FIG. 2 illustrates an exemplary embodiment of a control center and electrolytic cell assembly for a chlorinating system of an artificial body of water.

FIG. 3 illustrates an exemplary side, perspective view of the electrolytic cell assembly illustrated in FIG. 2.

FIG. 4 illustrates a cross-sectional side view of the electrolytic cell assembly illustrated in FIG. 3.

FIG. 5A illustrates a left-side, perspective view of an electrode assembly of the electrolytic cell assembly shown in FIG. 4 according to one exemplary embodiment.

FIG. 5B illustrates a right-side, perspective view of an electrode assembly shown in FIG. 5A.

FIG. 6 illustrates a rear, perspective view of an electrode assembly cap of the electrode assembly shown in FIGS. 5A and 5B without any epoxy potting shown in some of the prior figures.

FIG. 7A illustrates a rear view of the electrode assembly shown in FIGS. 5A and 5B according to a first exemplary embodiment with a first sectional line A-A′ being positioned on a first rod of the electrode assembly.

FIG. 7B illustrates a cross-sectional view of a portion of the electrode assembly of FIG. 7A taken along the sectional line A-A′ in FIG. 7A.

FIG. 8A illustrates a rear view of the electrode assembly shown in FIGS. 5A and 5B according to the first exemplary embodiment, similar to FIG. 7A, but with a second sectional line B-B′ being positioned on a second rod of the electrode assembly.

FIG. 8B illustrates a cross-sectional view of a portion of the electrode assembly of FIG. 8A taken along the sectional line B-B′ in FIG. 8A.

FIG. 9 illustrates an exploded view of a portion of the electrode assembly shown in FIGS. 7B and 8B that does not include the cell housing cap or the electrode assembly cap shown in FIGS. 7B and 8B.

FIG. 10A illustrates a side view of one of the electrode blades of the electrode assembly shown in FIG. 9 having a first blade configuration.

FIG. 10B illustrates a side view of one of the electrode blades of the electrode assembly shown in FIG. 9 having a second blade configuration.

FIG. 11A illustrates the first exemplary embodiment of the electrode assembly in which five electrode blades are employed.

FIG. 11B illustrates a second exemplary embodiment of the electrode assembly in which three electrode blades are employed.

FIG. 11C illustrates a third exemplary embodiment of the electrode assembly in which seven electrode blades are employed.

FIG. 11 D illustrates a fourth exemplary embodiment of the electrode assembly in which nine electrode blades are employed.

### DETAILED DESCRIPTION OF PREFERRED EMBODIMENTS

In the following detailed description, for purposes of explanation and not limitation, exemplary, or representative, embodiments disclosing specific details are set forth in order to provide a thorough understanding of the inventive principles and concepts. The word “exemplary” is used herein to mean “serving as an example, instance, or illustration”. Any aspect described herein as “exemplary” is not necessarily to be construed as exclusive, preferred or advantageous over other aspects.

It will be apparent to one of ordinary skill in the art having the benefit of the present disclosure that other embodiments according to the present teachings that are not explicitly described or shown herein are within the scope of the appended claims. Moreover, descriptions of well-known apparatuses and methods may be omitted so as not to obscure the description of the exemplary embodiments. Such methods and apparatuses are clearly within the scope of the present teachings, as will be understood by those of skill in the art.

The terminology used herein is for purposes of describing particular embodiments only and is not intended to be limiting. Any specifically-defined terms are in addition to the technical, scientific, or ordinary meanings of the defined terms as commonly understood and accepted in the relevant context. The terms “a,” “an” and “the” include both singular and plural referents, unless the context clearly dictates otherwise. Thus, for example, “a device” includes one device and plural devices. The terms “electrolytic chlorinator” and “electrolytic cell assembly” are used interchangeably herein.

The terms “substantial” or “substantially” mean to within acceptable limits or degrees acceptable to those of skill in the art. For example, the term “substantially parallel to” means that a structure or device may not be made perfectly parallel to some other structure or device due to tolerances or imperfections in the process by which the structures or devices are made. The term “approximately” means to within an acceptable limit or amount to one of ordinary skill in the art.

Relative terms, such as “over,” “above,” “below,” “top,” “bottom,” “front,” “back,” “upper” and “lower” may be used to describe the various elements' relationships to one another, as illustrated in the accompanying drawings. These relative terms are intended to encompass different orientations of the device and/or elements in addition to the orientation depicted in the drawings. For example, if the device were inverted with respect to the view in the drawings, an element described as “above” another element, for example, would now be below that element.

Embodiments and aspects of the present invention provide improved devices and methods for chlorinating spas, swimming pools, hot tubs, garden baths, and the like, that are not susceptible to the limitations and deficiencies of the prior art. The inventive concepts described herein, in certain non-limiting embodiments, allow for replacement of individual electrode blades or multiple electrode blade assemblies within a salt cell. In other words, with the inventive system, the whole blade sub-assembly can be replaced if desired/needed as well as individual blades. One advantage with this inventive system is that the blade sub-assembly can be replaced without requiring the replacement of the cell cap and cord at the same time.

With the above context in mind, a first exemplary embodiment of the inventive concepts provides an efficient, effective, and versatile chlorinating system for a pool or spa, wherein the system comprises an electrode assembly, a cap for supporting the electrode assembly, and a housing for enveloping the electrode assembly and exposing the electrode assembly to an inlet and outlet of the housing. The cap is removable from the housing and allows for the individual replacement of single and/or multiple electrode blades forming the electrode blade assembly.

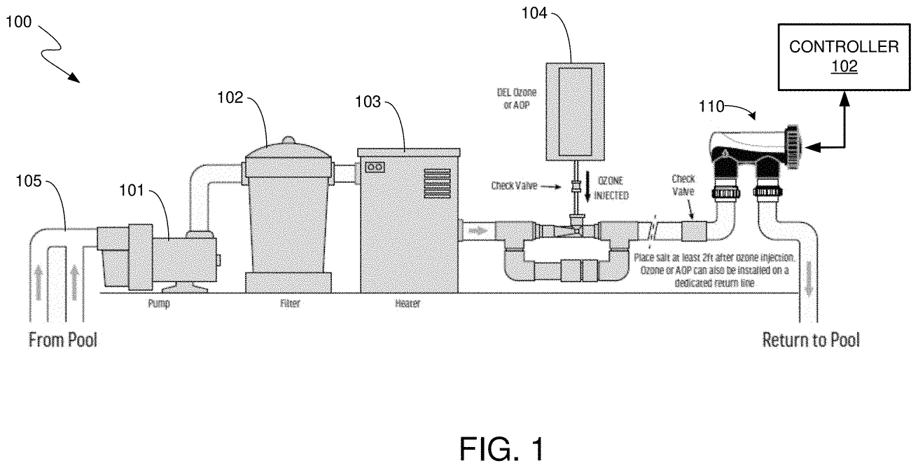

Referring now to the drawings, wherein the showings are for purposes of illustrating the various embodiments of the present invention only and not for purposes of limiting the same, FIG. 1 is a diagram of a filtration and chlorinating system 100 for an artificial body of water, like a pool or spa, that includes a pump 101, a filter 102, a heater 103, an ozone injector 104, an electrolytic chlorinator 110, a control center 102 coupled to the chlorinator 110, and piping 105 that couples each of these elements together. It should be recognized that other configurations for the filtration and chlorinating system 100 are possible and are included within the scope of this disclosure.

As a non-limiting example, it is possible that certain elements could be dropped or eliminated from the chlorinating system 100, but still practice the core components of the inventive system. For example, the heater 103 may be removed or not used, while the inventive aspects of the system are practiced for producing chlorine in an artificial body of water.

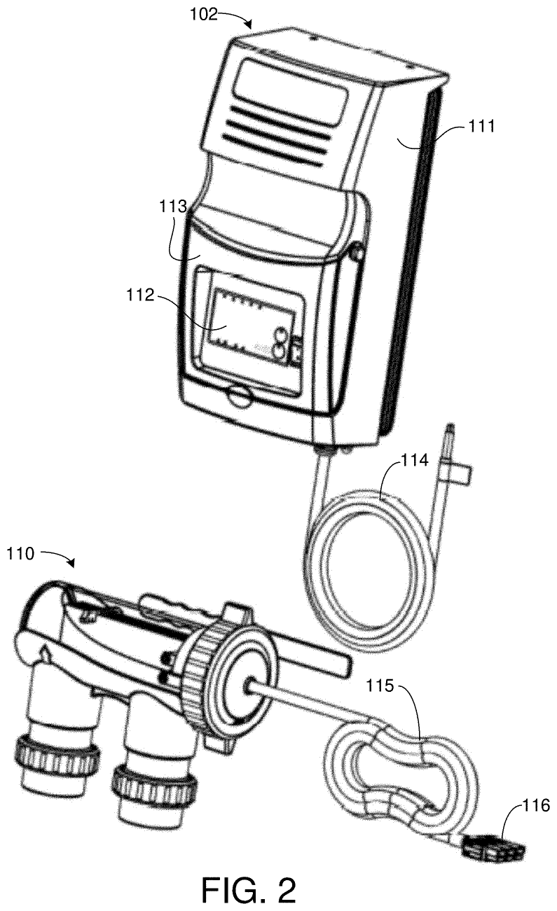

Referring now to FIG. 2, this figure illustrates an exemplary embodiment of the control center 102 and the electrolytic cell assembly 110 shown in FIG. 1. The control center 102 is electrically coupled to the electrolytic cell assembly 101 and provides power to an electrode blade assembly (not visible in FIG. 2) of the electrolytic cell assembly 110, as will be described below in more detail. The inventive principles and concepts are not limited to the control center 102 having any particular configuration or functionality, but it typically includes a housing 111, a control panel 112 that acts as a user interface, a transparent visor or cover 113 mechanically coupled to the housing 111 and disposed over the control panel 111 that can be opened to provide user access to the control panel 112 and closed to protect the control panel 112, and an electrical power cable 114.

The control center 102 may be configured to receive input power from a 110 volt (V)/120V or 220V alternating current (AC) power source (not shown). First and second ends of the electrical power cable 114 can be electrically coupled to electrical circuitry of the control center 102 and to the AC power source, respectively. The control center 102 may receive a max current of 2.2 amps at 220V or 4.4 amps at 110V/120V, according to one exemplary embodiment. Other electrical current and voltage levels are possible and are included within the scope of this disclosure.

The control center 102 may comprise a transformer that converts the AC input power to an 18V DC output power that is sent to the electrolytic cell assembly 110 via a power cable 115 that is electrically coupled on one end of the cable 115 to the electrolytic cell assembly 110. The opposite end of the cable 115 is electrically coupled to the control center 102 via a 3-pin connector 116 disposed on the end of the cable 115.

When the user interfaces with input elements (e.g., buttons, icons, etc.) of the control panel 112 of the control center 102, this can cause adjustments to be made to the electrical current sent to the blades of the electrolytic cell assembly 110 to change the amount of chlorine produced. According to one exemplary embodiment, five output levels are output from the control center 102 to the electrolytic cell assembly 110, and they may be provided at 20% increments. However, other output levels higher or lower are possible, such as at 10% increments, for example, as will be understood by one of ordinary skill in the art. The output level may be varied by controlling a firing angle of a semiconductor switch of the control center 102 while converting the AC input signal to a direct current (DC) output signal using pulse width modulation (PWM) and a microcontroller of the control center 102, as understood by one of ordinary skill in the art.

According to one exemplary embodiment, the control center 102 may communicate via a wired or wireless link with a portable computing device (PCD), such as a mobile phone, for example. The control center 102 may send to the PCD various types of alerts, such as, but not limited to, salinity, chlorine level, flow sensor readings, pH levels, oxidation-reduction potential (ORP), temperature, etc.

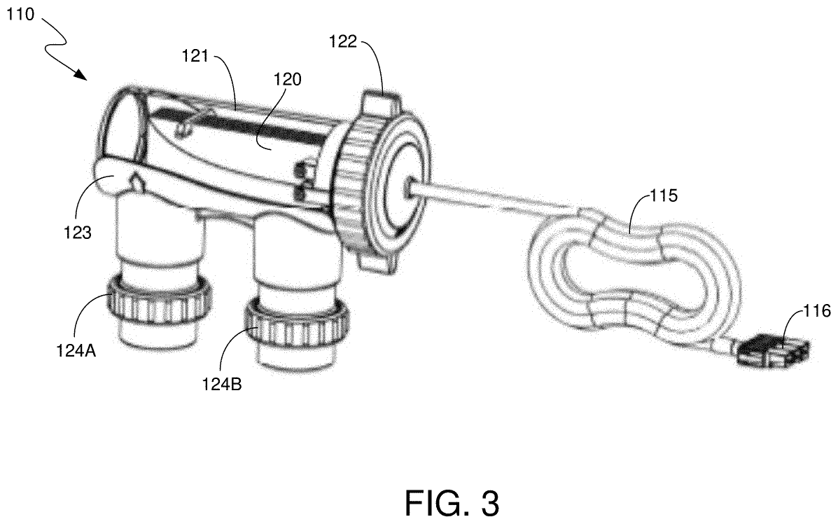

Referring now to FIG. 3, this figure illustrates an exemplary side, perspective view of the electrolytic cell assembly 110 illustrated in FIG. 2. The electrolytic cell assembly 110 may comprise a housing 121 that may be transparent, or clear, a cell housing cap 122, and an electrode assembly 120 positioned within the volume, or interior compartment, defined by the housing 121. Outside the housing 121 may be positioned a structural saddle 123 configured to seat the housing 121. The structural saddle 123 may be coupled to both an inlet union fitting 124A and an outlet union fitting 1248. The first end of the cable 115 passes through an opening in the cell housing cap 122 and is mechanically and electrically coupled to the electrode assembly 120. As indicated above, the second end of the cable 115 may be electrically coupled to the control center 102 via the connector 116.

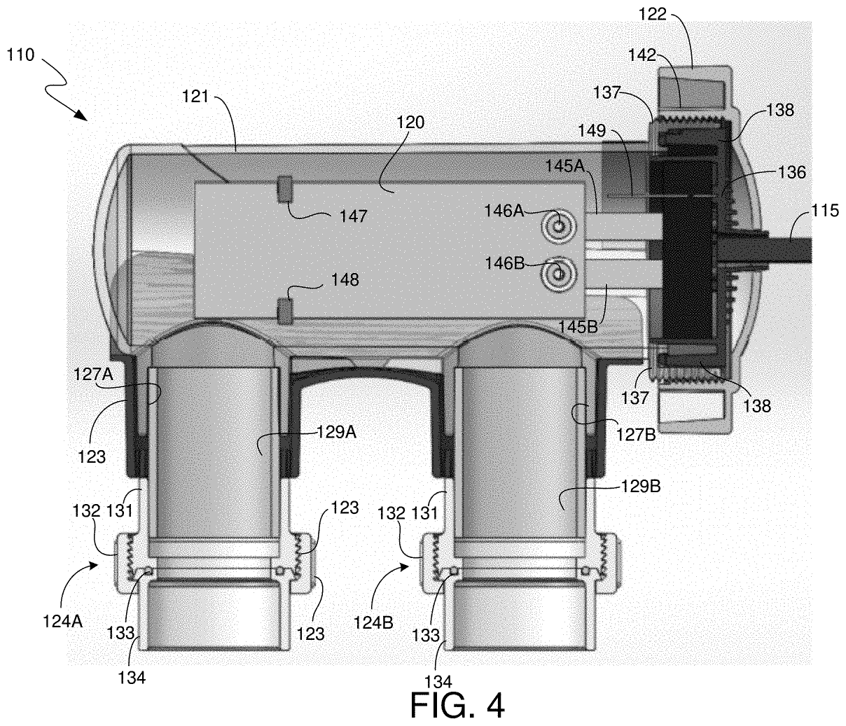

Referring now to FIG. 4, this figure illustrates a cross-sectional view of the electrolytic cell assembly 110 illustrated in FIG. 3. The structural saddle 123 may install over inlet and output ports 127A and 127B, respectively, of the cell housing 121 at the bottom of the cell housing 121 and may offer additional structural strength and protection against cracking of the cell housing 121 if the plumbing for the inlet port 127A and/or outlet port 1278 are not properly aligned. Specifically, misaligned pipes will usually put additional loading on the ports 127A, 127B. The saddle 123 may help prevent cracking under these loading conditions.

The inlet and outlet ports 127A and 127B, respectively, of the cell housing 121 may be female ports configured to receive short (e.g., approximately 3.0 inches to about 4.0 inches) pieces of PVC pipe 129A and 1298, respectively. The pipes 129A and 129B may be secured to the ports 127A and 127B, respectively, via any suitable mechanism (e.g., with adhesive). After the saddle 123 is installed over the ports 127A, 127B, the saddle 123 can be secured to the ports 127A and 127B by any suitable mechanism (e.g., adhesive).

The union fittings 124A and 1248 can each comprise a union half 131, a fitting nut 132, an O-ring 133, and a tail fitting 134. The inner surfaces of the union halves 131 of the union fittings 124A and 124B can be secured to the outer surfaces of the pieces of PVC pipe 129A and 1298, respectively. Threads on the interior surfaces of the respective fitting nuts 132 engage threads on the outer surfaces of the respective union halves 131 to secure the nuts 132 to the union halves 131.

This threading engagement also secures the respective tail fittings 134 to the respective union fittings 124A and 124B as it can be seen in FIG. 4 that upper portions of the tail fittings 134 are captured within the respective union nuts 132 when the union nuts 132 are brought into threading engagement with the respective union halves 131. The union fittings 124A and 1248 allow for the cell housing 121 to be easily replaced if it is damaged or at its end of life by disassembling the union fittings 124A and 124B.

In an alternate embodiment (not shown), the union threads could be molded into the ports 127A, 127B on the cell housing 121. The saddle 123 could be made in two halves to snap or bolt together around the cell housing 121 above the threads and achieve a similar appearance and performance to the electrolytic cell assembly shown in FIG. 4. It should be noted that the inventive principles and concepts of the present disclosure are not limited with respect to the construction or configuration of the cell housing 121 or the saddle 123 as many variations can be made to the housing 121 and the saddle 123 while still achieving the goals disclosed herein.

An electrode assembly cap 136 can be removably secured to a forward, or proximal, end of the cell housing 121 such that a circumferential portion 137 of the cell housing 121 surrounds a circumferential portion 138 of the electrode assembly cap 136 with inner surfaces of the circumferential portion 137 of the cell housing 121 being in contact with outer surfaces of a circumferential portion 138 of the electrode assembly cap 136. The outer surface of the circumferential portion 137 of the cell housing 121 can be threaded. An inner surface of a circumferential portion 142 of the cell housing cap 122 can be threaded to threadingly engage the threaded outer surface of the circumferential portion 137 of the cell housing 121.

Within an interior compartment of the cell housing 121, a parallel stack of electrode blades comprising the electrode assembly 120 are held in position by four potted leads 145A-145D (only two potted leads being visible in FIG. 4) and by four sets of coupling elements 146A-146D (only two sets being visible in FIG. 4), which mechanically and electrically couple the potted leads 145A-145D to the electrode assembly 120, and by first and second brackets 147 and 148, respectively. A sensor tab 149 has a proximal end that is secured to the electrode assembly cap 136 and electrically coupled to one or more electrical leads of the cable 115. A distal end of the sensor tab 149 extends into the interior compartment of the cell housing 121 and is disposed to contact water flowing in the cell housing 121.

The cable 115 has respective electrical leads (not shown) that are connected to the electrode assembly cap 136 and that are electrically coupled with the potted leads 145A-145D and with the sensor tab 149. The inside of the electrode assembly cap 136 is filled with a potting epoxy that covers these electrical connections. These electrical connections allow electrical signals to be communicated via cable 115 between the control center 102 and the electrolytic cell assembly 110.

To enable a user to gain access to the electrode assembly 120 to, for example, replace one or more faulty electrode blades with one or more new electrode blades, the user unscrews the cell assembly cap 122 to disengage it from the threaded outer surface on the circumferential portion 137 of the cell housing 121. The user then exerts a force on the electrode assembly cap 136 in a direction away from the cell housing 121 to pull the electrode assembly 120 coupled to the cap 136 by the potted leads 145A-145D and the four sets of coupling elements 146A-146D out of the interior compartment of the cell housing 121.

The user can then disconnect the four sets of coupling elements 146A — 146D and remove the brackets 147 and 148 to disassemble the electrode assembly 120. The user can then replace one or more faulty or corroded electrode blades with one or more new electrode blades and reassemble the coupling elements 146A-146D and the brackets 147 and 148. Holding the electrode assembly 120 by the cap 136, the user slides the electrode assembly 120 back into the interior compartment of the cell housing 121 until the cap 136 recouples with the circumferential portion 137 of the cell housing 121, and then screws the cell housing cap 122 back onto the threaded circumferential portion 137 of the cell housing 121.

The process of replacing one or more of the electrode blades is greatly beneficial for a number of reasons, including, for example, (1) individual plates are easier and less costly to stock than entire stacks of electrode blades and/or electrode assemblies, (2) delay periods that often occur when ordering replacement parts can be shortened or eliminated entirely, (3) the cost to the customer of replacing one or more electrode blades can be less than the cost of replacing the entire stack of electrode blades or the entire electrode assembly, (4) the total number of components that need to be kept in stock can be reduced, which reduces overall operating costs, and (5) there is less waste created when replacing only the components that need replacing and less impact to the environment.

As indicated above, with prior art chlorinators, the electrode blades are often welded together and then embedded in epoxy disposed on the rear side of the electrode assembly cap, making it virtually impossible to replace a single electrode plate. The incorporation of the potted leads, 145A-145D, the coupling elements 146A-146D and the brackets 147, 148 into the chlorinator cell assembly design of the present disclosure solves this problem, while at the same time providing the above benefits.

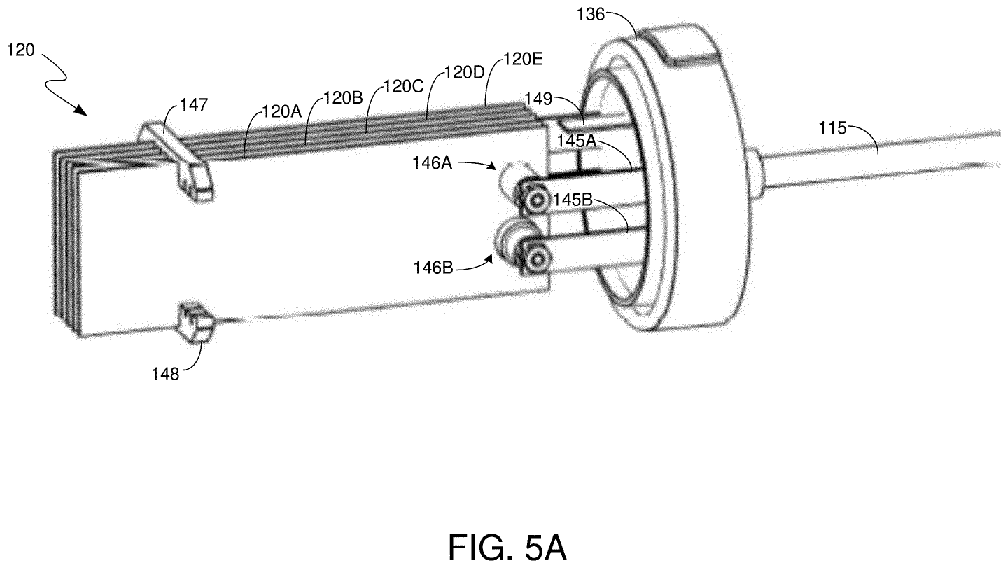

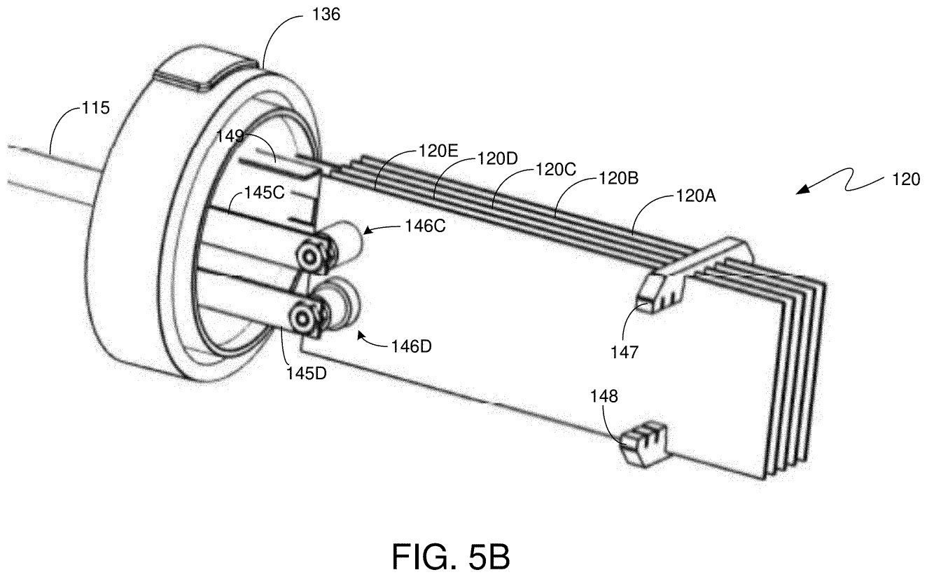

FIG. 5A illustrates a left-side, perspective view of the electrode assembly 120 of the electrolytic cell assembly 110 shown in FIG. 4 according to one exemplary embodiment. FIG. 5B illustrates a right-side, perspective view of the electrode assembly 120 shown in FIG. 5A. The electrode assembly 120 may comprise N electrode blades, where N is a positive integer that is greater than or equal to two. According to the exemplary embodiment of FIGS. 5A and 5B, the electrode assembly 120 includes five electrode blades 120A, 120B, 120C, 120D, and 120E. It is understood by one of ordinary skill in the art that any number or combination of blades 120A-120N may be employed without departing from the scope of this disclosure. It is also recognized that usually at least two blades 120A and 120B will be employed (i.e., a cathode blade and an anode blade).

The blades 120A-120E are coupled to the electrode assembly cap 136 by four sets of coupling elements 146A-146D (only coupling element sets 146A and 146B are visible in FIG. 5A, whereas only coupling element sets 146C and 146D are visible in FIG. 5B) and by potted electrical leads 145A-145D (only electrical leads 145A and 145B are visible in FIG. 5A, whereas only electrical leads 145C and 146D are visible in FIG. 5B). The blades 120A-120E may further be supported along upper and lower edges of the blades 120A-120E by an electrode bracket structure comprising electrode brackets 147 and 148, respectively. The edges of the blades 120A-120E are received in respective notches formed in the electrode brackets 147 and 148. The electrode brackets 147 and 148 are preferably made from non-conductive, i.e., electrically-insulating, materials as the electrode brackets 147, 148 support all of the blades 120A-120E. The brackets 147, 148 may be made as a single structure or may be separate devices that are attached to one another for ease of installation/removal to/from the electrode blades 120A-120E. The electrode assembly cap 136 may include an O-ring as well as potting material that encapsulates the proximal ends (i.e., the bases) of the potted leads 145A-145D.

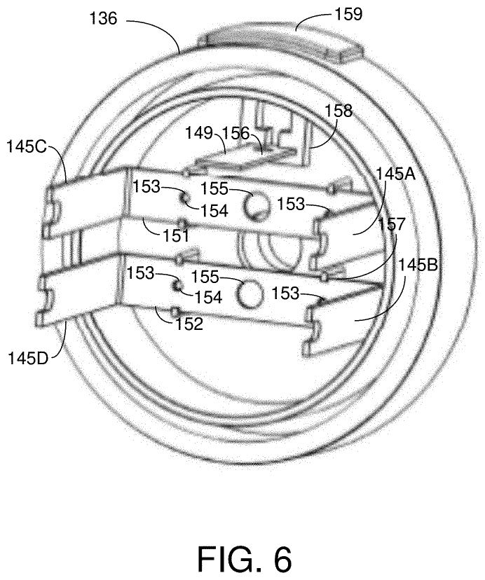

Referring now to FIG. 6, this figure illustrates a rear, perspective view of the electrode assembly cap 136 and the potted leads 145A-145D shown in FIGS. 5A and 5B. In accordance with this exemplary embodiment, the potted leads 145A, 145B and 145C, 145D are portions of upper and lower brackets 151 and 152, respectively. The upper and lower brackets 151 and 152, respectively, comprise an electrically-conductive material, such as Titanium, for example. The brackets 151 and 152 can be generally U-shaped and can have bases that are secured to the rear surface of the electrode assembly cap 136 by fastening devices 154 (e.g., screws, snaps, friction fit elements, etc.) that extend through respective openings 153 formed in the bases of the brackets 151 and 152.

The bases of the brackets 151 and 152 can have holes 155 formed therein thru which electrically-conductive leads of the cable 115 can be fed for attachment to the bases of the brackets 151 and 152. One of the brackets 151, 152 is connected to positive polarity and the other is connected to negative polarity. It does not matter which of the brackets 151, 152 is at positive or negative polarity and the polarity can be reversed. The sensor tab 149 can have a hole 156 formed therein thru which a lead of the cable 115 can be fed for attachment to the top surface of the sensor tab 149.

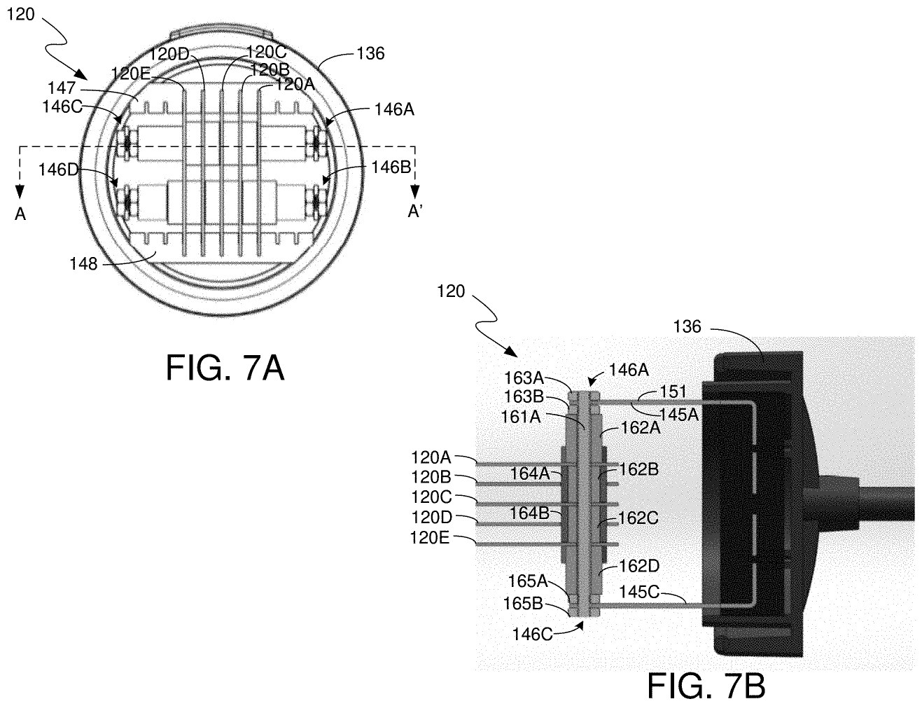

Distal ends of the potted leads 145A-145D can have notches formed therein that are shaped and sized to receive a threaded rod (not shown) of the sets of coupling elements 146A-146D, as will be described below in more detail with reference to FIGS. 7A-9.

The rear surface of the electrode assembly cap 136 can have molded features 157, 158 formed thereon (e.g., outward projections) to facilitate proper positioning and alignment of the brackets 151, 152 and of the sensor tab 149. Similarly, the electrode assembly cap 136 can have one or more molded features 159 formed thereon that act as a keying tab(s) to ensure proper orientation of the sensor tab 149 within the interior compartment of the cell housing 121 to enable it to detect the presence of water in the cell housing 121. The sensor tab 149 may be used by the control center 102 to sense/detect conductivity to determine if water is present across the electrode blades 120A-120E. The control center 102 can be configured to shut off the electrical power to the blades 120A-120E if no water is detected with the sensor tab 149.

After the brackets 151, 152 and the sensor tab 149 have been secured to the rear surface of the electrode assembly cap 136 and the leads of the cable 115 have been connected, the rear surface of the cap 136 can be filled with a potting epoxy (not shown) that covers the electrical connections, further secures these elements to the rear surface of the cap 136, and seals the opening formed in the cap 136 for passage of cable 115. Alternatively, the opening for cable passage can be sealed by a grommet, a strain relief fitting, or other fittings/methods known in the art.

According to one or more other exemplary embodiments, other sensors may be employed to sense other important pool related parameters, such as, but not limited to, salinity, chlorine concentration, pH level, ORP (oxidation reduction potential), temperature, flow rate, or other parameters that may be displayed on a display device of the control panel 112 (FIG. 2) of the control center 102 or relayed to a remote portable computing device (PCD), such as a mobile phone.

It should be noted that the inventive principles and concepts of the present disclosure are not limited with respect to the manner in which the electrode blades 120A-120N are electrically coupled to electrical conductors of the cable 115 or with respect to the mechanical configuration that is used to support the electrode blades 120A-120N within the interior compartment of the cell housing 121. The brackets 147, 148 and 151, 152 and the sets of coupling elements 146A-146D are one of many possible configurations for performing these electrical and mechanical functions in a way that makes it relatively easy to replace the electrode blades 120A-120N and/or the electrode assembly 120 and to clean the electrode blades 120A-120N. Any suitable mechanical and electrical configuration that allows the electrode assembly to be assembled and disassembled to allow individual electrode blades to be removed and replaced is within the scope of the present disclosure. Those of skill in the art will understand, in view of the present disclosure, how to arrive at suitable mechanical/electrical configurations for achieving these goals.

FIG. 7A illustrates a rear view of the electrode assembly 120 shown in FIGS. 5A and 5B according to a first exemplary embodiment. FIG. 7B illustrates a cross-sectional side view of the cap 136 of FIG. 7A taken along the line A-A′, which cuts through a first, upper threaded rod 161A that is shared by the first and third sets of coupling elements 146A and 146C, respectively (FIGS. 5A and 5B).

Referring now to FIG. 7B, electrically-conductive spacer 162A is used to make electrical contact between electrode plate 120A and the potted lead 145A of the upper bracket 151. Electrically-conductive spacer 162B is used to make electrical contact between electrode blades 120A and 120C. Electrically-conductive spacer 162C is used to make electrical contact between electrode plate 120C and electrode plate 120E. Electrically-conductive spacer 162D is used to make electrical contact between electrode plate 120E and the potted lead 145C of the upper bracket 151.

A first set of electrically-conductive upper and lower nuts 163A and 163B, respectively, threadingly engage a first end of the first, upper threaded rod 161A on opposite sides of the potted lead 145A to secure the rod 161A to the potted lead 145A and to electrically connect the spacer 162A to the potted lead 145A. A second set of electrically-conductive upper and lower nuts 165A and 165B, respectively, threadingly engage a second end of the first, upper threaded rod 161A on opposite sides of the potted lead 145C to secure the rod 161A to the potted lead 145C and to electrically connect the spacer 162D to the potted lead 145C.

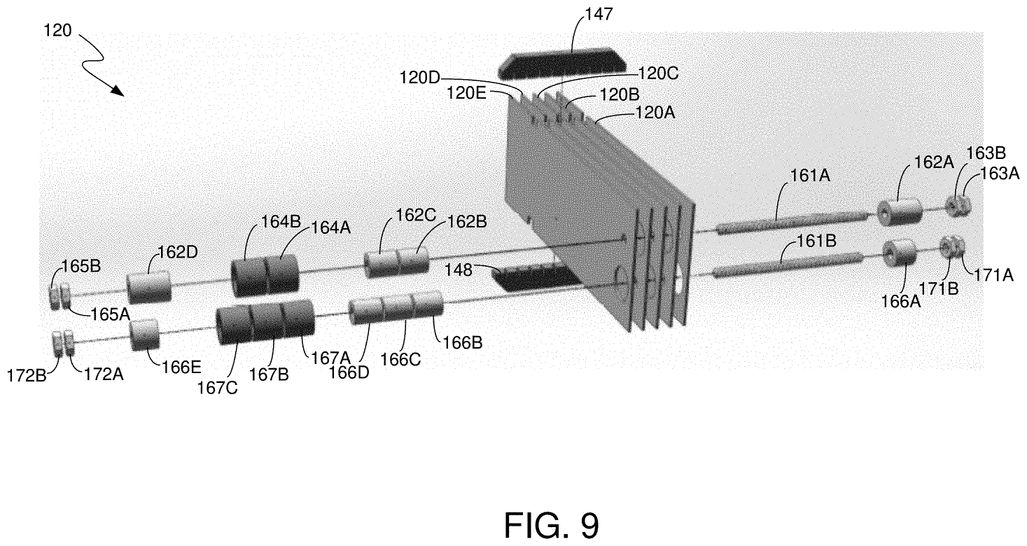

Electrically-insulating spacers 164A and 164B are used to insulate electrode blades 120B and 120D from electrode blades 120A, 120C and 120E and from the potted leads 145A and 145C. The manner in which the electrically-conductive spacers 162A-162C and the electrically-insulating spacers 164A and 164B perform electrical coupling or electrical insulating functions will be described below in more detail with reference to FIG. 9.

According to this exemplary embodiment shown in FIG. 7B, the first, third, and fifth blades 120A, 120C and 120E, respectively, are electrically coupled with the upper bracket 151 while the second and fourth blades 120B and 20D, respectively, are insulated from the upper bracket 151.

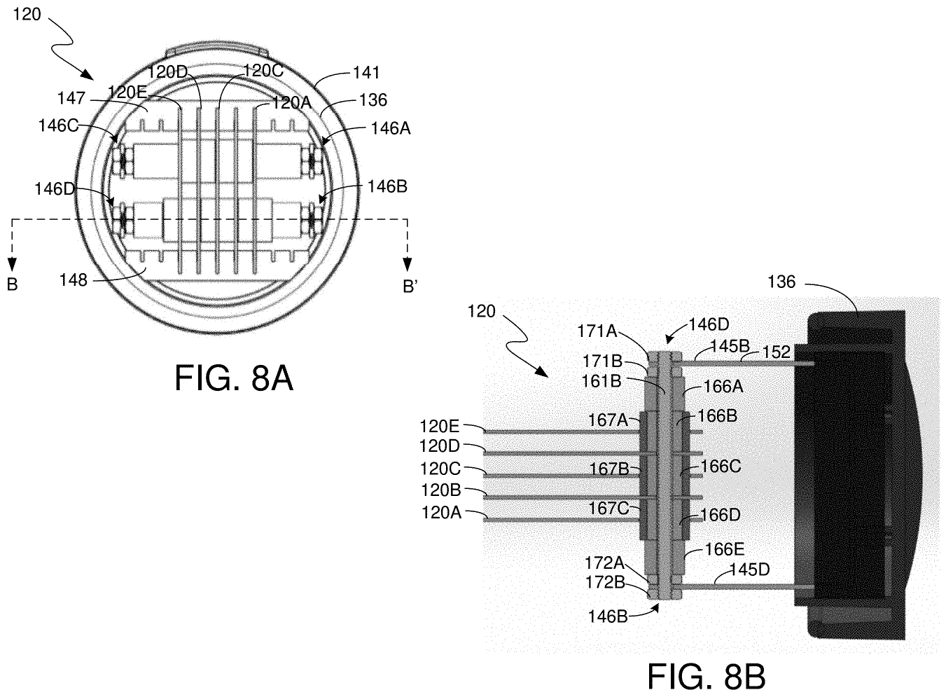

FIG. 8A illustrates a rear view of the electrode assembly 120 shown in FIGS. 5A and 5B according to a first exemplary embodiment. FIG. 8B illustrates a cross-sectional side view of the cap 136 of FIG. 8A taken along the line B-B′, which cuts through a second, lower threaded rod 161B that is shared by the second and fourth sets of coupling elements, 146A and 146C, respectively (FIGS. 5A and 5B).

Referring now to FIG. 8B, electrically-conductive spacer 166A is used to make electrical contact between electrode blade 120D and the potted lead 145B of the lower bracket 152 via electrically-conductive spacer 166B, which is in contact with spacer 166A and with plate 120D. Electrically-conductive spacer 166C is used to make electrical contact between electrode blades 120B and 120D. Electrically-conductive spacer 166D is used to make electrical contact between electrode plate 120B and the potted lead 145D via electrically-conductive spacer 166E.

A third set of electrically-conductive upper and lower nuts 171A and 171B, respectively, threadingly engage a first end of the second, lower threaded rod 161B on opposite sides of the potted lead 145B to secure the rod 161B to the potted lead 145B and to electrically connect the spacer 166A to the potted lead 145B. A fourth set of electrically-conductive upper and lower nuts 172A and 172B, respectively, threadingly engage a second end of the second, lower threaded rod 161B on opposite sides of the potted lead 145D to secure the rod 161B to the potted lead 145D and to electrically connect the spacer 166E to the potted lead 145D.

Electrically-insulating spacer 167A is used to insulate electrode plate 120E from electrically-conductive spacers 166A and 166B. Electrically-insulating spacer 167B is used to insulate electrode plate 120C from electrically-conductive spacers 166B and 166D. Electrically-insulating spacer 167C is used to insulate electrode plate 120A from electrically-conductive spacers 166D and 166E. The manner in which the electrically-conductive spacers 166A-166E and the electrically-insulating spacers 167A-167C perform electrical coupling or electrical insulating functions will be described below in more detail with reference to FIG. 9.

The electrically-conductive materials of which the electrically-conductive spacers are made may be any suitable electrically-conductive material, such as titanium, for example. The electrically-insulating material of which the electrically-insulating spacers are made may be any suitable electrically-insulating material, such as polytetrafluoroethylene (PTFE), for example. However, other electrically-conductive and electrically-insulating materials are possible and are included within the scope of this disclosure as understood by one of ordinary skill in the art.

According to this exemplary embodiment shown in FIG. 8B, the second and fourth blades 120B and 20D are electrically coupled with the lower bracket 152 while the first, third, and fifth blades 120A, 120C and 120E, respectively, are insulated from the lower bracket 152. As indicated above, the upper and lower brackets 151 and 152, respectively, are connected to opposite polarities, and thus the blades 120A, 120C and 120E are at positive or negative polarity and the blades 120B and 120D are at the opposite polarity.

The control center 102 may alternate polarity periodically during use of the system: for example, in a five-blade cell, three blades may be set to positive polarity and while two are set for negative polarity, and then, the control center 102 may alternate the polarity (where this polarity change may happen at regular intervals as controlled by the control center 102 so the time the system spends in each polarity setting is the same or equal over time). This reversal in polarity for the blades may help prevent scale buildup. This is often called “reversing polarity” and is sometimes called a “self-cleaning mode,” in the industry.

According to one exemplary embodiment, a default setting may have three of five blades at positive polarity while the remaining two blades are at negative polarity when the product is assembled. However, as noted above, the polarities settings may change during testing and before shipment from the manufacturer to a consumer.

Referring now to FIG. 9, this figure illustrates an exploded view of the electrode blade assembly 120 shown in FIGS. 7A-8B. The sequence of the electrically-conductive and electrically-insulating spacers as well as the orientation of the first, upper rod 161A and second, lower rod 161B are presented. As indicated above, a variety of other arrangements for the electrode assembly 120 are possible and are within the scope of the present disclosure.

FIGS. 7A-9 show a combination of elements or components associated with electrically and mechanically coupling/decoupling the electrode assembly 120 to/from the cap 136 and/or electrically and mechanically coupling/decoupling the electrode blades to/from other electrode blades and/or to/from one of the brackets 151, 152. This combination of elements/components comprises a mechanical and electrical coupling and decoupling system of the electrode assembly 120, referred to hereinafter as a “mechanical/electrical coupling/decoupling system”. The mechanical/electrical coupling/decoupling system includes the components shown in FIG. 9 as well as the brackets 151, 152 shown in, for example, FIGS. 6, 7B and 8B and the elements/components that are used for electrically and/or mechanically coupling/decoupling the brackets 151, 152 to/from the cap 136 and to/from electrical contacts of the cable 115.

The mechanical/electrical coupling/decoupling system can have different designs and can take on different configurations while still allowing individual electrode blades to be changed out, or swapped, with new electrode blades, as will be understood by those of skill in the art in view of the present disclosure. One of the benefits of the design of the electrode assembly 120 discussed in the examples disclosed herein is that the electrode assembly 120 can be easily removed from the cell housing 121 by removing the cell housing cap 122 (FIG. 4) and then removing the electrode assembly from the housing 121 by removing the electrode assembly cap 136. The components shown in FIG. 9 are then disassembled, the electrode blade(s) to be replaced is removed, the components shown in FIG. 9 are reassembled with the new electrode blade(s) in position, the electrode assembly cap 136 is coupled to the cell housing 121, and the cell housing cap 122 is coupled to the cell housing 121. As indicated above, this is not possible with other chlorinator cells currently on the market.

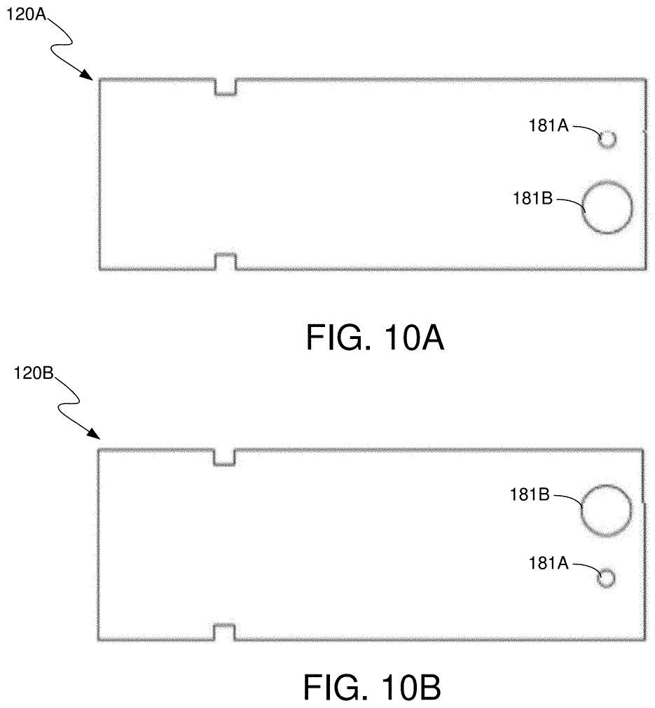

Referring now to FIG. 10A, this figure illustrates a side view of the first electrode blade 120A shown in FIGS. 7A-9, which has the same configuration as the third and fifth electrode blades 120C and 120E, respectively, shown in FIGS. 7A-9. The electrode blades 120A, 120C and 120E have a first substantially circular opening 181A formed therein having a first diameter and a second substantially circular opening 181B formed therein having a second diameter that is larger than the first diameter. When the electrode assembly 120 is in its assembled state, the first, upper threaded rod 161A extends through the first substantially circular openings 181A formed in the electrode blades 120A, 120C and 120E and the second, lower threaded rod 161B extends through the second substantially circular openings 181B formed in the electrode blades 120A, 120C and 120E.

Referring now to FIG. 10B, this figure illustrates a side view for the second electrode blade 120B shown in FIGS. 7A-9, which has the same configuration as the fourth electrode blade 120D shown in FIGS. 7A-9. The electrode blades 120B and 120D have the first and second substantially circular openings 181A and 181B formed therein, but their locations are the reverse of the locations shown in FIG. 10A.

When the electrode assembly 120 is in its assembled state, the first, upper threaded rod 161A extends through the first substantially circular openings 181A formed in the electrode blades 120A, 120C and 120E and through the second substantially circular openings 181B formed in the electrode blades 120B and 120D. The second, lower threaded rod 161B extends through the second substantially circular openings 181B formed in the electrode blades 120A, 120C and 120E and through the first substantially circular openings 181A formed in the electrode blades 120B and 120D.

The first diameter of the first opening 181A is the same size or slightly larger than the diameter of the first, upper threaded rod 161A and smaller than the outer diameters of the electrically-conductive and electrically-insulating spacers so that the rod 161A passes through the opening 181A, but the spacers abut the blades at the openings 181A rather than passing through them. The second diameter of the second opening 181B is the same size or slightly larger than the outer diameters of the electrically-conductive and electrically-insulating spacers so that spacers can extend through the openings 181B while the rods 161A, 161B pass through the openings 181B. The electrically-conductive and electrically-insulating spacers are arranged, or ordered, along the rods 161A, 161B relative to the blades 102A-120N such that proper spacing between adjacent blades is achieved and such that the blades are electrically connected or electrically isolated to/from one another and to/from the brackets 151, 152 to achieve the desired electrical polarities as selected by the control center 102.

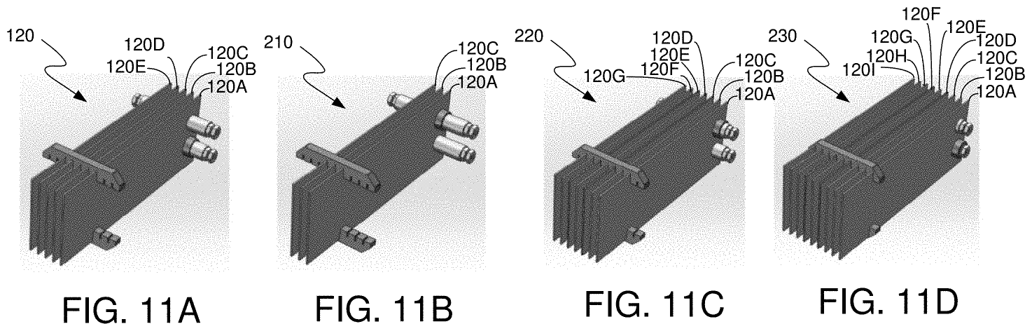

Referring now to FIG. 11A, this figure illustrates the first exemplary embodiment of the electrode assembly 120 in which five electrode blades 120A-120E are employed. This first exemplary emboiment of the electrode assembly 120 typically is used to support artificial bodies of water having up to 40K gallons.

Referring now to FIG. 11B, this figure illustrates a second exemplary embodiment of the electrode assembly 210 in which three electrode blades 120A, 120B and 120C having the configurations shown in FIGS. 10A and 10B are employed. This second exemplary embodiment of the electrode assembly 210 typically is used to support artificial bodies of water having up to 20K gallons.

Referring now to FIG. 11C, this figure illustrates a third exemplary embodiment of the electrode assembly 220 in which seven electrode blades 120A, 120B, 120C, 120D, 120E, 120F, and 120G are employed. In this embodiment, the electrode blades 120F and 120G can have the configurations shown in FIGS. 10B and 10A, respectively. This third exemplary embodiment of the electrode assembly 220′ typically is used to support artificial bodies of water having up to 60K gallons.

Referring now to FIG. 11D, this figure illustrates a fourth exemplary embodiment of the electrode assembly 230 in which nine electrode blades 120A, 120B, 120C, 120D, 120E, 120F, 120G, 120H, and 120I are employed. In this embodiment, the electrode blades 120H and 120I can have the configurations shown in FIGS. 10A and 10B, respectively. This fourth exemplary embodiment of the electrode assembly 230 typically is used to support artificial bodies of water having up to 80K gallons.

It can be seen from a comparison of the electrode assemblies shown in FIGS. 11A-11D that the outer-most spacers are different lengths depending on the blade count. The outer-most spacers are longer in the axial direction of the rods 161A, 161B for lower blade counts in order to fill the gaps between the outer-most blades and the respective potted leads. The outer-most spacers are shorter in the axial direction of the rods 161A, 161B as blade count increases due to the smaller gaps between the outer-most blades and the respective potted leads.

The chlorinating system 100, its components and methods described herein may be used on almost any artificial water body. While the chlorinating system 100, components and methods are described in connection with a pool and spa, it is understood that the chlorinating system 100, components and methods may be used on spas, swimming pools, tubs, Jacuzzis, and the like. One of ordinary skill in the art can modify the chlorinating system 100 without undue experimentation so that it can be placed on almost any artificial water body. Thus, the invention may be installed within pool or spa walls or shells to provide for efficient chlorinating of a pool or spa. Specifically, the system may be installed outside of a pool in an area known as “the pad”: the pad is usually where the pump, filter, and heater are located relative to a pool. The pad is typically positioned adjacent to a house (residential) or in an equipment room, as understood by one of ordinary skill in the art.

The various components of the invention can be manufactured from relatively inexpensive materials. Appropriate components are molded or formed from a plastic material that will not corrode or be adversely affected from the exposure to water, particularly chlorinated water, and other chemicals present in a spa setting. Other appropriate components are formed from materials such as steel, aluminum, other metals, rock, acrylic, fiberglass, etc. as aesthetically or structurally needed or desired. Such materials are known to one of ordinary skill in the art.

The foregoing detailed description of the preferred embodiments and the appended figures have been presented only for illustrative and descriptive purposes and are not intended to be exhaustive or to limit the scope and spirit of the invention. The embodiments were selected and described to best explain the principles of the invention and its practical applications. One of ordinary skill in the art will recognize that many variations can be made to the invention disclosed in this specification without departing from the scope and spirit of the invention.

For example, while several of the electrode blades 120A-120N are shown to have a rectangular shape, other shapes are possible and are included within the scope of this disclosure. Other shapes include, but are not limited to, square, circular, pentagonal, hexagonal, octagonal, and other similar shapes.

Similarly, while fasteners such as screws are shown, other fasteners may be used without departing from the scope of this disclosures. Other fasteners may include, but are not limited to, rivets, adhesives, locking geometries made from plastics, etc.

While detailed descriptions of the preferred embodiments are provided herein, as well as the best mode of carrying out and employing the present invention, it is to be understood that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure, or manner.

What is claimed is:

1. A electrolytic chlorinator system comprising:
an electrode assembly comprising a plurality of electrode blades;
a cap mechanically coupled to the electrode assembly; and a housing for enveloping the electrode assembly in an internal compartment of the housing and exposing the electrode assembly to an inlet and outlet of the housing, wherein the cap is removable from the housing and allows for the individual replacement of single electrode blades forming the electrode assembly.

2. The system of claim 1, wherein the electrode assembly includes a mechanical and electrical coupling and decoupling system (mechanical/electrical coupling/decoupling system) configured such that removal of the cap from the housing and exertion of a force on the cap in a direction away from the housing results in removal of the electrode assembly from the internal compartment of the housing, and wherein the mechanical/electrical coupling/decoupling system includes components that can be disassembled and reassembled to perform said individual replacement of single electrode blades.

3. The system of claim 2, wherein the components of the mechanical/electrical coupling/decoupling system comprise:
a first set of components for electrically coupling one or more of the electrode blades to one or more other electrode blades of the electrode assembly; and
a second set of components for electrically decoupling, or insulating, one or more of the electrode blades from one or more of the other electrode blades of the electrode assembly.

4. The system of claim 3, wherein the first set of components comprises:
at least a first electrically-conductive rod that passes through openings formed in the electrode blades in a direction substantially perpendicular to the electrode blades: and
one or more electrically-conductive spacers removably mounted on the rod and extending between at least two of the electrode blades.

5. The system of claim 4, wherein the second set of components comprises:
one or more electrically-insulating spacers removably mounted on the rod and in contact with at least a first electrode blade of the plurality of electrode blades for electrically insulating the first electrode blade from at least one other electrode blade of the plurality of electrode blades.

6. The system of claim 4, wherein the components of the mechanical/electrical coupling/decoupling system further comprise:
a third set of components for electrically coupling the first electrically-conductive rod with one or more electrical contacts disposed on a rear side of the cap, the third set of components including a pair of electrical leads, wherein one electrical lead of the pair is electrically coupled to a first end of the first electrically-conductive rod and one electrical lead of the pair is electrically coupled to a second end of the first electrically-conductive rod.

7. The system of claim 6, wherein the electrical leads of the pair of electrical leads are respective portions of an electrically-conductive bracket having a base that is secured to the rear side of the cap.

8. The system of claim 7, wherein the components of the mechanical/electrical coupling/decoupling system further comprise:
a fourth set of components comprising:
first and second sets of coupling elements, the first set of coupling elements electrically and mechanically coupling one of the electrical leads of the pair of electrical leads to the first end of the first electrically-conductive rod and the second set of coupling elements coupling the other of the electrical leads of the pair of electrical leads to the second end of the first electrically-conductive rod; and

9. The system of claim 4, wherein the first set of components further comprises:
at least a second electrically-conductive rod that passes through openings formed in the electrode blades in a direction substantially perpendicular to the electrode blades; and
one or more electrically-conductive spacers removably mounted on the second electrically-conductive rod and extending between at least two of the electrode blades.

10. The system of claim 9, wherein the second set of components further comprises:
one or more electrically-insulating spacers removably mounted on the second electrically-conductive rod and in contact with at least a second electrode blade of the plurality of electrode blades for electrically insulating the second electrode blade from at least one other electrode blade of the plurality of electrode blades.

11. The system of claim 9, wherein the components of the mechanical/electrical coupling/decoupling system further comprise:
a third set of components for electrically coupling the second electrically-conductive rod with one or more electrical contacts disposed on a rear side of the cap, the third set of components including a pair of electrical leads, wherein one electrical lead of the pair is electrically coupled to a first end of the second electrically-conductive rod and one electrical lead of the pair is electrically coupled to a second end of the second electrically-conductive rod.

12. The system of claim 11, wherein the electrical leads of the pair of electrical leads are respective portions of an electrically-conductive bracket having a base that is secured to the rear side of the cap.

13. The system of claim 12, wherein the components of the mechanical/electrical coupling/decoupling system further comprise:
a fourth set of components comprising:
first and second sets of coupling elements, the first set of coupling elements electrically and mechanically coupling one of the electrical leads of the pair of electrical leads to the first end of the second electrically-conductive rod and the second set of coupling elements coupling the other of the electrical leads of the pair of electrical leads to the second end of the second electrically-conductive rod.

14. The system of claim 2, wherein the components of the mechanical/electrical coupling/decoupling system further comprise:
a bracket structure having an upper bracket that receives upper edges of each electrode blade and a lower bracket that receives lower edges of each electrode blade, the electrode blades being held by the bracket structure substantially in parallel to one another.

15. A method for use in an electrolytic chlorinator system comprising an electrode assembly, the electrode assembly comprising a plurality of electrode blades, a cap electrically and mechanically coupled to the electrode assembly, and a housing for enveloping the electrode assembly in an internal compartment of the housing and exposing the electrode assembly to an inlet and outlet of the housing, the method comprising:
removing the cap from the housing to thereby remove the electrode assembly from the internal compartment of the housing;
at least partially disassembling the electrode assembly;
replacing one or more of the electrode blades with one or more respective replacement electrode blades;
reassembling the at least partially disassembled electrode assembly such that the reassembled electrode assembly includes said one or more replacement electrode blades; and
coupling the cap to the housing such that the reassembled electrode assembly is enveloped in the internal compartment of the housing.

16. The method of claim 15, wherein the electrode assembly includes a mechanical and electrical coupling and decoupling system (mechanical/electrical coupling/decoupling system) configured such that removal of the cap from the housing and exertion of a force on the cap in a direction away from the housing results in removal of the electrode assembly from the internal compartment of the housing, and wherein the mechanical/electrical coupling/decoupling system includes components that are disassembled and reassembled during the disassembling and reassembling steps, respectively, to perform the step of replacing one or more of the electrode blades with one or more respective replacement electrode blades.

17. The system of claim 16, wherein the components of the mechanical/electrical coupling/decoupling system comprise:
a first set of components for electrically coupling one or more of the electrode blades to one or more other electrode blades of the electrode assembly; and
a second set of components for electrically decoupling, or insulating, one or more of the electrode blades from one or more of the other electrode blades of the electrode assembly.

18. The method of claim 17, wherein the first set of components comprises:
at least a first electrically-conductive rod that passes through openings formed in the electrode blades in a direction substantially perpendicular to the electrode blades: and one or more electrically-conductive spacers removably mounted on the rod and extending between at least two of the electrode blades.

19. The method of claim 18, wherein the second set of components comprises:
one or more electrically-insulating spacers removably mounted on the rod and in contact with at least a first electrode blade of the plurality of electrode blades for electrically insulating the first electrode blade from at least one other electrode blade of the plurality of electrode blades.

20. The method of claim 18, wherein the components of the mechanical/electrical coupling/decoupling system further comprise:
a third set of components for electrically coupling the first electrically-conductive rod with one or more electrical contacts disposed on a rear side of the cap, the third set of components including a first pair of electrical leads, wherein one electrical lead of the pair is electrically coupled to a first end of the first electrically-conductive rod and one electrical lead of the pair is electrically coupled to a second end of the first electrically-conductive rod.

21. The method of claim 18, wherein the first set of components further comprises:
at least a second electrically-conductive rod that passes through openings formed in the electrode blades in a direction substantially perpendicular to the electrode blades; and
one or more electrically-conductive spacers removably mounted on the second electrically-conductive rod and extending between at least two of the electrode blades.

22. The method of claim 21, wherein the second set of components further comprises:
one or more electrically-insulating spacers removably mounted on the second electrically-conductive rod and in contact with at least a second electrode blade of the plurality of electrode blades for electrically insulating the second electrode blade from at least one other electrode blade of the plurality of electrode blades.
